(19) United States
(12) Patent Application Publication
(10) Pub. No.: US 2013/0042031 A1
(43) Pub. Date: Feb. 14, 2013

(54) METHOD AND APPARATUS FOR CONTROLLING CONNECTION

(71) Applicants: Hee-chul JEON, Suwon-si (KR); Yong-gook PARK, Yongin-si (KR); Tae-young KANG, Seoul (KR); Seung-hwan HONG, Seoul (KR); Bum-joo LEE, Yongin-si (KR)

(72) Inventors: Hee-chul JEON, Suwon-si (KR); Yong-gook PARK, Yongin-si (KR); Tae-young KANG, Seoul (KR); Seung-hwan HONG, Seoul (KR); Bum-joo LEE, Yongin-si (KR)

(73) Assignee: Samsung Electronics Co., Ltd.

(21) Appl. No.: 13/396,189

(22) Filed: Feb. 14, 2012

(30) Foreign Application Priority Data
Aug. 12, 2011 (KR) 10-2011-0080647

(51) Int. Cl. G06F 13/14

(52) U.S. Cl. 710/36

(57) ABSTRACT

A connection control method including receiving intrinsic information of a neighboring external device from the external device; detecting time information indicating a time at which the intrinsic information is received; and controlling a connection to the external device based on the intrinsic information and the time information.

### PRIORITY

This application claims priority under 35 U.S.C. §119(a) to Korean Patent Application No. 10-2011-0080647, filed on Aug. 12, 2011, in the Korean Intellectual Property Office, the disclosure of which is incorporated herein by reference.

### BACKGROUND OF THE INVENTION

1. Field of the Invention

The present invention relates generally to a method and apparatus for controlling a connection, and more particularly, to a method and apparatus for controlling a connection to an external device according to the number of connections to the external device.

2. Description of the Related Art

A wireless Local Area Network (LAN) that operates as a close distance communication network, and that facilitates high Internet speeds within a local coverage area where an access point, or more specifically, a wireless access device, is installed is referred commonly referred to as Wireless Fidelity network, or a “Wi-Fi” network.

The amount of Wi-Fi devices produced annually is rapidly increasing with the increased sale of mobile devices that handle large amounts of traffic, such as, for example, smart phones, tablets, and mobile Personal Computers (PCs). The number of access points are also rapidly increasing in accordance with the increase the number of Wi-Fi devices.

The large number of access points causes an increase in the number of access points that are connected to a single mobile device.

### SUMMARY OF THE INVENTION

The present invention has been made to address at least the above problems and/or disadvantages and to provide at least the advantages described below. Accordingly, an aspect of the present invention provides a method and apparatus for controlling a connection to an external device.

According to an aspect of the present invention, a connection control method is provided. Intrinsic information of an external device that neighbors a connection control apparatus is received at the connection control apparatus from the external device. Time information indicating a time at which the intrinsic information is received is detected. A connection between the connection control apparatus and the external device is controlled based on the intrinsic information and the time information.

According to another aspect of the present invention, a connection control apparatus is provided. The connection control apparatus includes a communication unit for receiving intrinsic information of an external device that neighbors the connection control apparatus, from the external device. The connection control apparatus also includes a control unit for detecting time information indicating a time at which the intrinsic information is received, and controlling a connection between the connection control apparatus and the external device based on the intrinsic information and the time information.

According to a further aspect of the present invention, an article of manufacture is provided for controlling a connection. The article of manufacture includes a computer readable recording medium containing one or more programs which when executed implement the steps of: receiving, at a connection control apparatus, intrinsic information of an external device that neighbors the connection control apparatus, from the external device; detecting time information indicating a time at which the intrinsic information is received; and controlling a connection between the connection control apparatus and the external device based on the intrinsic information and the time information.

### BRIEF DESCRIPTION OF THE DRAWINGS

The above and other aspects, features and advantages of the present invention will become more apparent from the following detailed description when taken in conjunction with the accompanying drawings in which:

FIG. 1 is a diagram illustrating a system for providing a location-based service, according to an embodiment of the present invention;

FIG. 2 is a flowchart illustrating a connection control method, according to an embodiment of the present invention;

FIG. 3 is a diagram illustrating the connection control method of FIG. 2, according to an embodiment of the present invention;

FIG. 4 is a flowchart illustrating of an operation of controlling a connection to an external device of FIG. 2, according to an embodiment of the present invention;

FIGS. 5A through 5C are tables for describing a list, according to an embodiment of the present invention;

FIGS. 6A and 6B are tables for describing a list, according to another embodiment of the present invention;

FIG. 7 is a diagram illustrating a connection control method of FIG. 4, according to an embodiment of the present invention; and

FIG. 8 is a block diagram illustrating a connection control apparatus, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

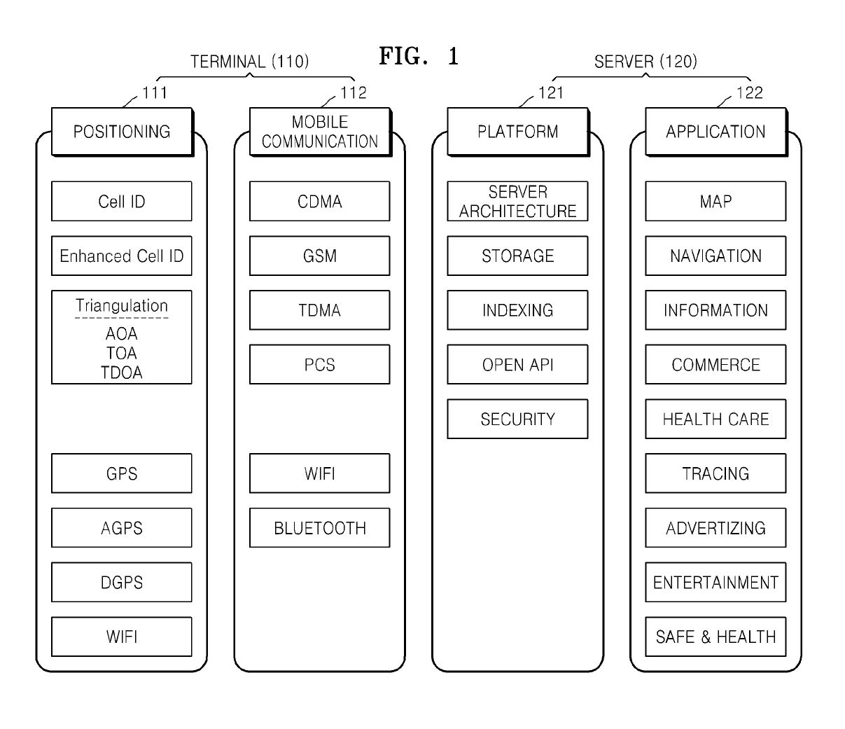

FIG. 1 is a diagram illustrating a system for providing a location-based service, according to an embodiment of the present invention.

Referring to FIG. 1, the system includes a terminal 110 and a server 120. The terminal 110 includes a positioning module 111 and a mobile communication module 112. The server 120 includes a platform 121 and an application 122.

The positioning module 111 checks a location of the terminal 110. The positioning module 111 uses technology such as, for example, a Global Positioning System (GPS), an Assisted GPS (AGPS), a Differential GPS (DGPS), WiFi, or triangulation. Triangulation may utilize ell IDentification (ID) positioning (Cell ID), enhanced cell ID positioning (Enhanced Cell ID), Angle of Arrival (AoA), Time of Arrival (ToA), or Time Difference of Arrival (TDoA) technologies. However, the positioning module 111 is not limited to the technologies described above.

The mobile communication module 112 allows the terminal 110 and the server 120 to communicate with each other. Technologies related to mobile communication include, for example, Code Division Multiple Access (CDMA), Global System for Mobile communications (GSM), Time Division Multiple Access (TDMA), and Personal Communication Service (PCS). Technologies related to local area communication include, for example, WiFi and Bluetooth. However, the mobile communication module 112 is not limited to the technologies described above.

The platform 121 may include, for example, server architecture technology, storage technology, indexing technology, open Application Programming Interface (API) technology, and security technology. The server architecture technology is a location-based technology for responding to a location information request of the terminal 110. The server architecture technology responds by obtaining a location from a location obtaining server, managing location information, processing location information of an individual or group, and tracking a movement route. The storage technology stores and manages large capacity information. The indexing technology systemizes location information, or information related to the location information, into an optimized form, and configures the location information to be easily searched. The open API technology is linked to provide location information and related information to another enterprise. The security technology is access regulation technology for a user, such as, for example, user profile management, certification, and security. However, the platform 121 is not limited to the technologies described above.

The application 122 provides a location-based service to the terminal 110. Examples of the application 122 include a map application, a navigation application, an information application, a commerce application, a health care application, a tracing application, an advertising application, an entertainment application, and a health and safety application. However, the application 122 is not limited to the applications described above.

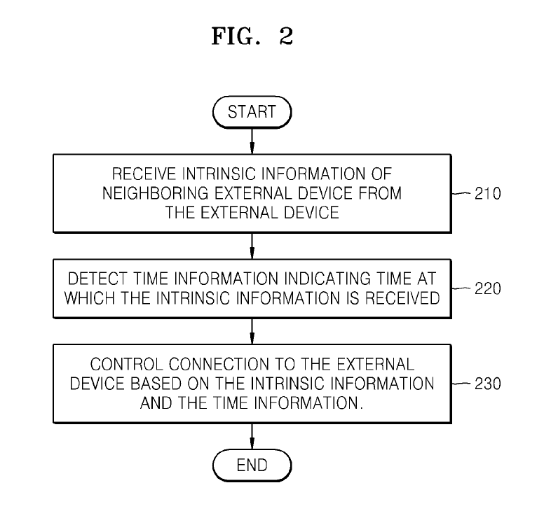

FIG. 2 is a flowchart illustrating a connection control method, according to an embodiment of the present invention. Referring to FIG. 2, in step 210, a connection control apparatus receives intrinsic information of an external device, which neighbors the connection control apparatus, from the external device.

In an embodiment of the present invention, the external device may be embodied as a wireless transceiver or a wireless access device, such as, for example, an access point. The access point may include a wireless Internet router. If the external device is the access point, when the connection control apparatus enters a coverage area of the access point, the connection control apparatus receives a Media Access Control (MAC) address, a Service Set IDentifier (SSID), timestamp information or signal strength information of the access point, from the access point. The information transmitted from the access point is not limited to the information described above. In an embodiment of the present invention, the intrinsic information of the access point may be the MAC address or the SSID.

Methods of connecting the access point to a terminal in which the connection control apparatus is embedded include, for example, a passive connection method and an active connection method. In the passive connection method, the access point broadcasts a beacon to the terminal. The terminal receives the beacon and sends an authentication request to the access point. The access point sends an authentication response to the terminal. Thereafter, the terminal sends an association request to the access point. The access point sends an association response to the terminal. Thus, the terminal and the access point are connected to each other.

In the active connection method, the terminal sends a probe request to the access point. The access point sends a probe response to the terminal. Thereafter, the terminal and the access point are connected to each other through authentication and association processes. In an embodiment of the present embodiment, at least one of the MAC address and the SSID, which are the intrinsic information of the external device, and the timestamp information are included in a beacon frame or a probe response frame.

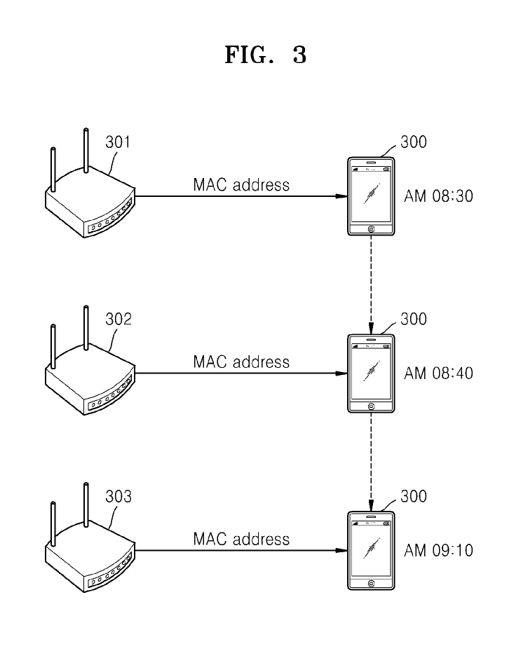

In step 220, the connection control apparatus detects time information at a time when the connection control apparatus receives the intrinsic information of the access point, which is the external device, from the external device. The connection control apparatus detects the time information from the timestamp information that is included in the beacon frame or the probe response frame, which is received from the access point. Alternatively, according to another embodiment of the present invention, the connection control apparatus may measure a time when at least one of the beacon frame, the probe response frame, an authentication response frame, and an association response frame are received from the access point. Steps 210 and 220 are described in greater detail below with respect to FIG. 3.

FIG. 3 is a diagram illustrating the connection control method of FIG. 2, according to an embodiment of the present invention.

Referring to FIG. 3, when a terminal 300 in which a connection control apparatus is embedded enters a coverage area of an access point 301, the terminal 300 receives a MAC address from the access point 301 and detects a time, 08:30 AM, at which the MAC address is received. Thereafter, when the terminal 300 enters a coverage area of an access point 302, the terminal 300 receives a MAC address from the access point 302 and detects a time, 08:40 AM, at which the MAC address is received. Thereafter, when the terminal 300 enters a coverage area of an access point 303, the terminal 300 receives a MAC address from the access point 303 and detects a time, 09:10 AM, at which the MAC address is received.

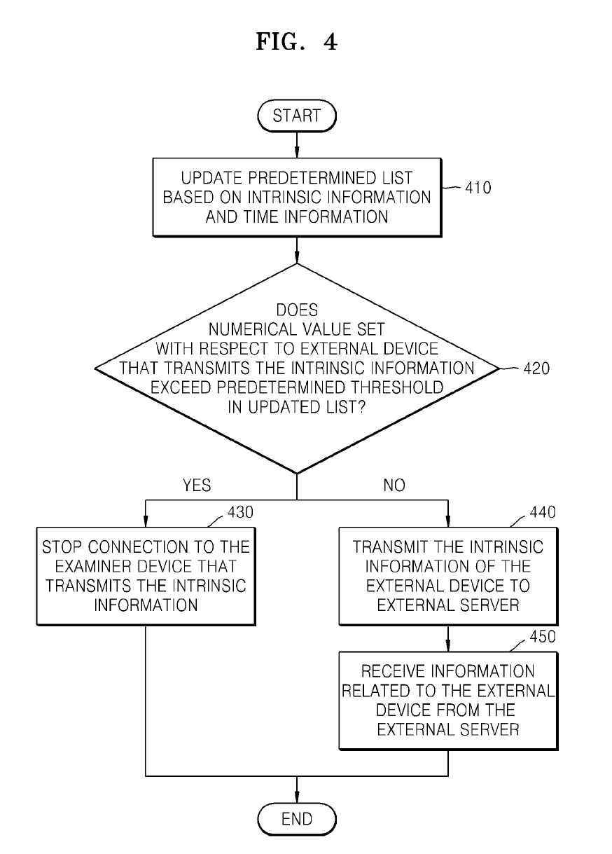

Referring back to FIG. 2, in step 230, the connection control apparatus controls a connection to the external device based on the received intrinsic information and the detected time information. For example, the connection control apparatus may disconnect from the access point, or may receive information related to the external device from an external server, based on the received intrinsic information and the detected time information, as is described in greater detail below with respect to FIG. 4.

FIG. 4 is a flowchart illustrating operation 230 of FIG. 2, according to an embodiment of the present invention. In step 410, the connection control apparatus updates a predetermined list based on the received intrinsic information and the detected time information. In an embodiment of the present invention, the predetermined list may be a list indicating a time at which the access point is detected and the number of detections. More specifically, the predetermined list may include the intrinsic information of the external device and information regarding the detected time and the number of detections. The number of detections may be presented as a predetermined numerical value or symbol value. Time slots, the numerical value, or the symbol value may be modified in accordance with embodiments of the present invention.

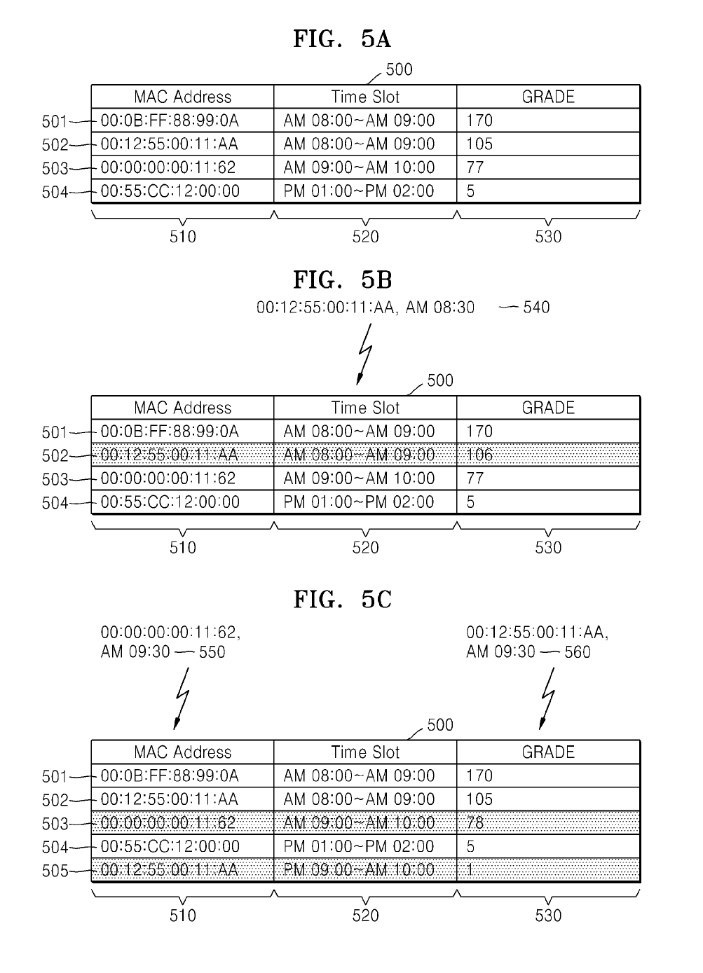

FIGS. 5A through 5C are tables for describing a list of step 410, according to an embodiment of the present invention.

Referring to FIG. 5A, a list 500 may include a MAC address field 510, a time slot field 520, and a grade field 530 for each of access points 501 through 504.

According to another embodiment of the present invention, a rule set by a user may be applied to the list 500. For example, a specific character string regarding information connected to the MAC address 510 may be filtered or a connection to all external devices, i.e. access points, connected to a predetermined time slot may be controlled.

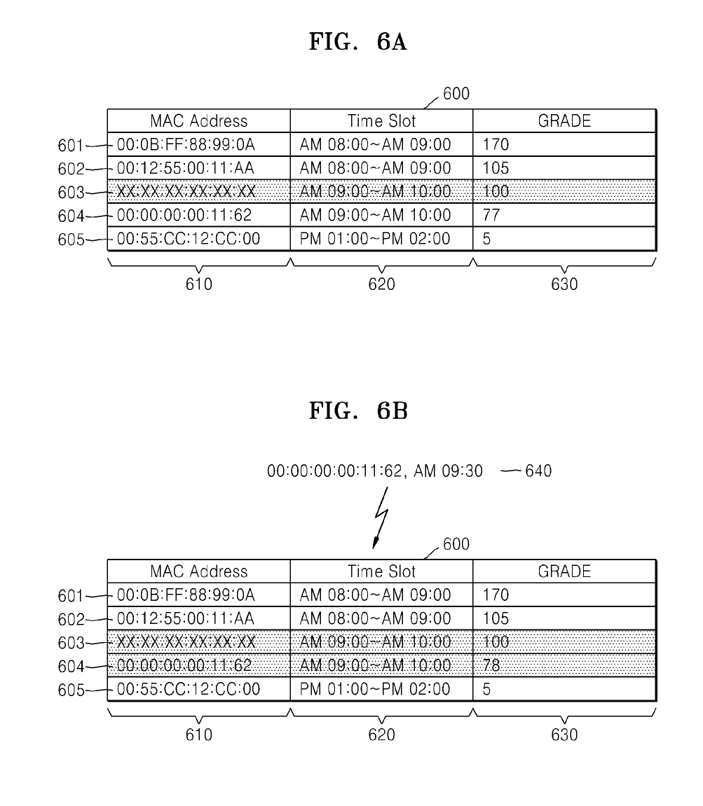

FIGS. 6A and 6B are tables for describing a list, according to another embodiment of the present invention.

Referring to FIG. 6A, a list 600 includes a connection control item regarding all access points connected from 09:00 AM˜10:00 AM, irrespective of a specific access point. Specifically, an item 603, set by a user, is XX:XX:XX:XX:XX:XX, 09:00 AM˜10:00 AM.

According to an updating method, a connection control apparatus receives a MAC address from an access point and detects a time at which the MAC address is received. Thereafter, the connection control apparatus checks if a time slot exists that corresponds to the time at which the MAC address is received. If the time slot exists, the connection control apparatus changes a corresponding grade. If a time slot does not exist, the connection control apparatus generates a time slot corresponding to the time from the list 600.

Referring to FIG. 5B, when the connection control apparatus receives a MAC address at 08:30 AM from an access point having a MAC address of 00:12:55:00:11:AA, 540, the connection control apparatus determines if the list 500 of FIG. 5A includes a time slot corresponding to 00:12:55:00:11:AA and 08:30 AM. Since the list 500 of FIG. 5A includes 00:12:55:00:11:AA and 08:30 AM˜09:00 AM, 502, the connection control apparatus changes a corresponding grade of 00:12:55:00:11:AA and 08:30 AM˜09:00 AM, 502, included in the list 500 of FIG. 5A, from 105 to 106. Referring to FIG. 5C, when the connection control apparatus receives a MAC address at 09:30 AM from an access point having a MAC address of 00:00:00:00:11:62, 550, and 00:12:55:00:11:AA, 560, the connection control apparatus determines if the list 500 of FIG. 5A includes a time slot corresponding to 00:00:00:00:11:62 and 00:12:55:00:11:AA and 09:30 AM. Since the list 500 of FIG. 5A includes 00:00:00:00:11:62 and 09:00 AM˜10:00 AM, 503, the connection control apparatus changes a corresponding grade of the 00:00:00:00:11:62 and 09:00 AM˜10:00 AM, 503, included in the list 500 of FIG. 5A, from 77 to 78. However, since the list 500 of FIG. 5A does not include 00:12:55:00:11:AA, 09:00 AM˜10:00 AM, the connection control apparatus records 00:12:55:00:11:AA, 09:00 AM 10:00 AM, 505 in the list 500 of FIG. 5A, and a grade of 1, as shown in FIG. 5C. Referring again to FIG. 4, in step 420, the connection control apparatus determines if a numeral value set with respect to the external device that transmits the intrinsic information in the updated list exceeds a predetermined threshold. The predetermined threshold can be changed by a user or a person authorized to access the connection control apparatus. In an embodiment of the present invention, a threshold is exceeded when there is frequent connection between the external device and the connection control apparatus. For example, an external device that is mostly connected to at a specific time exceeds a threshold.

Although step 420 is based on exceeding the threshold in determining whether a specific connection is common, embodiments of the present invention are not limited thereto.

For example, it is assumed that the predetermined threshold is set at a grade of 100 in FIGS. 5A through 5C. Specifically, in FIG. 5A, grades corresponding to 00:0B:FF:88:99:0A, 08:00 AM 09:00 AM, 501, and 00:12:55:00:11:AA, 08:00 AM 09:00 AM, 502, are 170 and 105, respectively, which exceed the threshold. In FIG. 5B, since the access point of 00:12:55:00:11:AA is received at 08:30 AM, a corresponding grade is 106, which exceeds the threshold. In FIG. 5C, since the access points of 00:00:00:00:11:62 and 00:12:55:00:11:AA are received at AM 09:30, corresponding grades are 78 and 1, which do not exceed the threshold.

In FIG. 6A, the access points received at 09:00 AM˜10:00 AM are set to exceed the threshold. In FIG. 6B, the access point of 00:00:00:00:11:62 is received at 09:30 AM, a corresponding grade is 78, which does not exceed the threshold. However, due to the previously set XX:XX:XX:XX:XX:XX, 09:00 AM˜10:00 AM, 603, the access point of 00:00:00:00:11:62 exceeds the threshold.

Referring back to FIG. 4, when the threshold is exceeded in step 420, the connection control apparatus stops itself from being connected to the external device that transmits the intrinsic information, in step 430. Alternatively, if the connection control apparatus is already connected to the external device, the connection control apparatus disconnects the external device. According to another embodiment of the present invention, the connection control apparatus blocks the reception of information related to a corresponding external device, or even if the information is received, the connection control apparatus does not display the information on a display device connected thereto.

When the threshold is not exceeded in step 420, the connection control apparatus transmits the intrinsic information of the external device to an external server, in step 440. Thereafter, the external server transmits information or content related to the external device to the connection control apparatus based on the intrinsic information of the external device, and the connection control apparatus receives the information or content, in step 450.

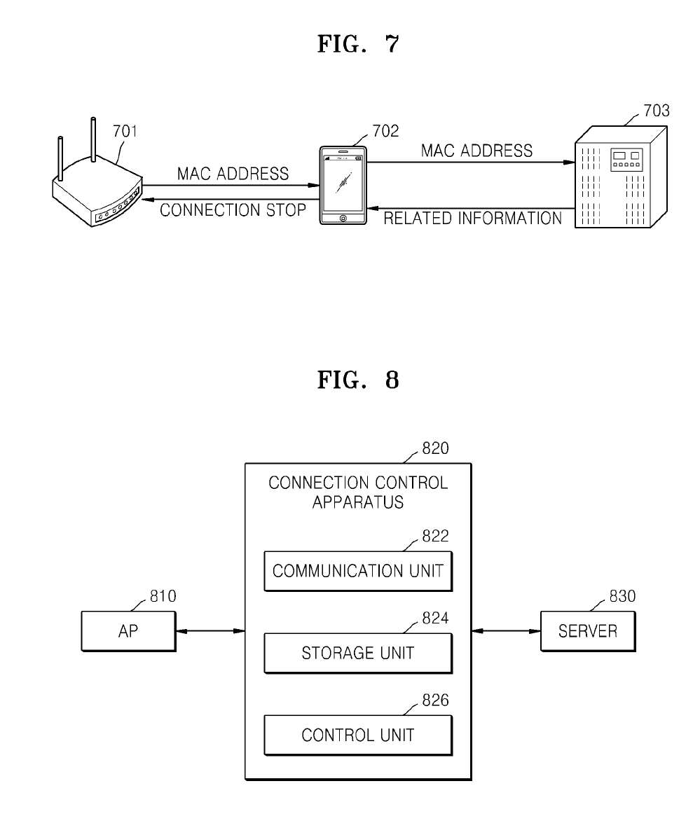

FIG. 7 is a diagram illustrating a connection control method, according to an embodiment of the present invention.

Referring to FIG. 7, a mobile device 702, in which an apparatus for performing the connection control method is embedded, may receive a MAC address from an access point 701, stop or remove itself from being connected to the access point 702 based on a predetermined condition, transmits the MAC address to an external server 703, and receives information or content related to the MAC address from the external server 703, in accordance with the steps of FIG. 4 described above.

FIG. 8 is a block diagram of a connection control apparatus 820, according to an embodiment of the present invention.

Referring to FIG. 8, the connection control apparatus 820 includes a communication unit 822, a storage unit 824, and a control unit 826. The connection control apparatus 820 is connected to an access point 810 and a server 830 over a predetermined network.

The communication unit 822 receives intrinsic information of an external device, which neighbors the connection control apparatus 820, from the external device. In FIG. 8, the external device may be a wireless transceiver, such as, for example, the access point 810. The access point 810 may include a wireless Internet router. When the connection control apparatus 820 enters a coverage area of the access point 810, the communication unit 822 receives a MAC address, an SSID, timestamp information or signal strength information of the access point 810, from the access point 810. The information transmitted from the access point 810 is not limited thereto. In an embodiment of the present invention, the intrinsic information of the access point 810 may be the MAC address or the SSID.

Methods of connecting the access point 810 to a terminal in which the connection control apparatus 820 is embedded include, for example, a passive connection method and an active connection method. In the passive connection method, the access point 810 broadcasts a beacon to the terminal. The terminal receives the beacon and sends an authentication request to the access point 810. The access point 810 sends an authentication response to the terminal. Thereafter, the terminal sends an association request to the access point 810. The access point 810 sends an association response to the terminal. Thus, the terminal and the access point 810 are connected to each other. In the active connection method, the terminal sends a probe request to the access point 810. The access point 810 sends a probe response to the terminal. Thereafter, the terminal and the access point 810 are connected to each other through authentication and association processes. In an embodiment of the present invention, at least one of the MAC address and the SSID, which are the intrinsic information of the external device, and the timestamp information are included in a beacon frame or a probe response frame.

The control unit 826 detects time information at the time when the connection control apparatus receives the intrinsic information of the access point 810 from the external device. The control unit 826 detects the time information from the timestamp information that is included in the beacon frame or the probe response frame received from the access point 810. Alternatively, according to another embodiment of the present invention, the control unit 826 may measure a time when at least one of the beacon frame, the probe response frame, an authentication response frame, and an association response frame, is received from the access point 810.

The control unit 826 controls a connection to the access point 810 based on the received intrinsic information and the detected time information. According to alternate embodiments of the present invention, the control unit 826 may stop the connection control apparatus 820 from being connected to the access point 810, disconnect the connection control apparatus 820 from the access point 810, or may receive information related to the access point 810 from the server 830, based on the received intrinsic information and the detected time information.

The control unit 826 updates a predetermined list based on the received intrinsic information and the detected time information, as described above with respect to FIGS. 5A through 5C. The list is stored in the storage unit 824. According to another embodiment of the present invention, a rule set by a user may be applied to the list, as described above with respect to FIGS. 6A and 6B. For example, the control unit 826 may filter a specific character string regarding information connected to a MAC address or, control a connection to all access points 810 connected to a predetermined time slot. According to an updating method, the communication unit 822 receives a MAC address from the access point 810, and the control unit 826 detects a time at which the MAC address is received. Thereafter, the control unit 826 checks if a time slot corresponding to the time at which the MAC address is received exists. If the time slot exists, the control unit 826 changes a corresponding grade. If the time slot does not exist, the control unit 826 generates a time slot corresponding to the time from the list.

The control unit 826 determines if a numeral value set with respect to the access point 810 that transmits the intrinsic information in the updated list exceeds the predetermined threshold. The predetermined threshold can be changed by a user or a person who is authorized to access the connection control apparatus 820.

The control unit 826 stops the connection control apparatus 820 from being connected to the external device that transmits the intrinsic information. Alternatively, if the connection control apparatus 820 is already connected to the access point 810, the control unit 826 removes the connection to the external device. According to another embodiment, the control unit 826 blocks receiving information related to a corresponding external device, or even if the information is received, does not display the information on a display device connected to the connection control apparatus 820.

The control unit 826 transmits the intrinsic information of the access point 810 to the server 830 through the communication unit 822. Thereafter, the server 830 transmits information or content related to the access point 810 to the connection control apparatus 820 based on the intrinsic information of the access point 810.

The invention can also be embodied as computer readable codes on a computer readable recording medium. The computer readable recording medium is any data storage device that can store data that can be thereafter read by a computer system. Examples of the computer readable recording medium include Read-Only Memory (ROM), Random-Access Memory (RAM), CD-ROMs, magnetic tapes, floppy disks, optical data storage devices, etc.

The computer readable recording medium can also be distributed over network coupled computer systems so that the computer readable code is stored and executed in a distributed fashion. Also, functional programs, codes, and code segments for accomplishing embodiments of the present invention can be easily construed by programmers of ordinary skill in the art to which the present invention pertains.

While the invention has been shown and described with reference to certain embodiments thereof, it will be understood by those skilled in the art that various changes in form and detail may be made therein without departing from the spirit and scope of the invention as defined by the appended claims. The preferred embodiments should be considered in a descriptive sense only and not for purposes of limitation.

What is claimed is:

1. A connection control method comprising the steps of:
receiving, at a connection control apparatus, intrinsic information of an external device that neighbors the connection control apparatus, from the external device;
detecting time information indicating a time at which the intrinsic information is received; and
controlling a connection between the connection control apparatus and the external device based on the intrinsic information and the time information.

2. The method of claim 1, wherein the external device comprises a wireless transceiver.

3. The method of claim 2, wherein the wireless transceiver comprises an access point.

4. The method of claim 3, wherein the intrinsic information comprises a Media Access Control (MAC) address.

5. The method of claim 1, wherein controlling the connection comprises:
updating a predetermined list based on the intrinsic information and the time information; and
controlling the connection between the connection control apparatus and the external device based on the predetermined list,
wherein the predetermined list is related to a number times intrinsic information is received.

6. The method of claim 5, wherein the predetermined list comprises numerical values set with respect to the number of times intrinsic information is received for the at least one external device according to the time at which the intrinsic information is received from at least one external device,
wherein the predetermined list is updated by changing the numerical value based on the intrinsic information and the time information.

7. The method of claim 5, wherein the predetermined list comprises numerical values set with respect to the number of time intrinsic information is received for the at least one external device according to the time at which the intrinsic information is received from at least one external device,
wherein the predetermined list is updated by generating the numerical value based on the intrinsic information and the time information.

8. The method of claim 5, wherein the predetermined list further comprises a predetermined condition set by a user of the connection control apparatus.

9. The method of claim 6, wherein controlling connection comprises, controlling the connection between the connection control apparatus and the external device, when a numerical value set with respect to the external device exceeds a predetermined threshold.

10. The method of claim 9, wherein controlling the connection comprises stopping the connection between the connection control apparatus and the external device.

11. The method of claim 9, further comprising:
transmitting the intrinsic information to an external server, when the numerical value set with respect to the external device does not exceed the predetermined threshold; and
receiving information related to the external device from the external server.

12. A connection control apparatus comprising:
a communication unit for receiving intrinsic information of a external device that neighbors the connection control apparatus, from the external device; and
a control unit for detecting time information indicating a time at which the intrinsic information is received, and controlling a connection between the connection control apparatus and the external device based on the intrinsic information and the time information.

13. The apparatus of claim 12, wherein the external device comprises a wireless transceiver.

14. The apparatus of claim 13, wherein the wireless transceiver comprises an access point.

15. The apparatus of claim 14, wherein the intrinsic information comprises a Media Access Control (MAC) address.

16. The apparatus of claim 12, further comprising a storage unit for storing a predetermined list,
wherein the control unit updates the predetermined list based on the intrinsic information and the time information, and controls the connection between the connection control apparatus and the external device based on the predetermined list, and
wherein the predetermined list is related to a number time intrinsic information is received.

17. The apparatus of claim 16, wherein the predetermined list comprises numerical values set with respect to the number of times intrinsic information is received for the at least one external device according to the time at which the intrinsic information is received from the at least one external device,
wherein the control unit changes the numerical value based on the intrinsic information and the time information.

18. The apparatus of claim 16, wherein the predetermined list comprises numerical values set with respect to the number of times intrinsic information is received for the at least one external device according to the time at which intrinsic information is received from the at least one external device,
wherein the control unit generates the numerical value based on the intrinsic information and the time information.

19. The apparatus of claim 16, wherein the predetermined list further comprises a predetermined condition set by a user of the connection control apparatus.

20. The apparatus of claim 17, wherein the control unit controls the connection between the connection control apparatus and the external device, when a numerical value set with respect to the external device exceeds a predetermined threshold.

21. The apparatus of claim 20, wherein the control unit stops the connection between the connection control apparatus and the external device.

22. The apparatus of claim 20, wherein the control unit transmits the intrinsic information to an external server, when the numerical value does not exceed the predetermined threshold, and
wherein the communication unit receives information related to the external device from the external server.

23. An article of manufacture for controlling a connection, comprising a computer readable recording medium containing one or more programs which when executed implement the steps of:
receiving, at a connection control apparatus, intrinsic information of an external device that neighbors the connection control apparatus, from the external device;
detecting time information indicating a time at which the intrinsic information is received; and
controlling a connection between the connection control apparatus and the external device based on the intrinsic information and the time information.
